(19) United States
(12) Patent Application Publication
(10) Pub. No.: US 2020/0124333 A1
(43) Pub. Date: Apr. 23, 2020

(54) ICE MAKER DOWNSPOUT

(71) Applicant: WHIRLPOOL CORPORATION, Benton Harbor, MI (US)

(72) Inventors: Jose R. Aranda, Stevensville, MI (US); Erdogan Ergican, St. Joseph, MI (US); Sann M. Naing, St. Joseph, MI (US)

(73) Assignee: WHIRLPOOL CORPORATION, BENTON HARBOR, MI (US)

(21) Appl. No.: 16/167,076

(22) Filed: Oct. 22, 2018

(51) Int. Cl. F25C 1/25; F15D 1/06; F15D 1/00

(52) U.S. Cl. CPC F25C 1/25; F25C 2400/10; F15D 1/001; F15D 1/06

(57) ABSTRACT

A downspout for delivering water to an ice tray in a refrigerated appliance includes a cavity defined by at least one flute and at least one lobe. The downspout includes an inlet port for receiving water. The at least one flute and at least one lobe are configured to create a substantially laminar flow of the water received from the inlet port along the at least one flute and the at least one lobe.

### BACKGROUND

Ice-making assemblies are commonly disposed within refrigerated appliances. It is therefore desirable to develop ice-making appliances and assemblies that improve the use of water during the ice-making process.

### SUMMARY

In at least one aspect, a downspout for delivering water to an ice tray in a refrigerated appliance includes a cavity defined by at least one flute and at least one lobe. The downspout also includes an inlet port for receiving water. The at least one flute and at least one lobe are configured to create a substantially laminar flow of the water received from the inlet port along the at least one flute and the at least one lobe.

In at least another aspect, a water delivery system for an ice tray of a refrigerated appliance includes a downspout. The downspout includes a cavity defined by one or more elongated protuberances and one or more elongated grooves. The downspout includes an inlet port and an outlet positionable above the ice tray. A water delivery member is coupled to the inlet port of the downspout.

In at least another aspect, a water delivery system for a refrigerated appliance includes an elongated downspout, a fill line, and an inlet segment. The elongated downspout includes a hollowed-out portion defined by one or more lobes and one or more flutes arranged in an alternating lobe and flute configuration along the walls of the hallowed-out portion, wherein the one or more lobes and the one or more flutes are longitudinally disposed in the direction of the elongated downspout. The fill line includes a first end coupled to a water source and a second end coupled to the elongated downspout. The inlet segment is coupled to the downspout and the fill line. The inlet segment extends toward the first end of the fill line. The inlet segment includes multiple cross-sectional variances along a length of a channel.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a front perspective view of a refrigerated appliance incorporating an ice maker;

FIG. 2 is a back perspective view of an icemaker for a refrigerated appliance incorporating a fill tube and a downspout, according to an aspect of the disclosure;

FIG. 3 is a perspective view of a fill tube with downspout disposed above an ice tray and water entering the ice tray from the downspout, according to an aspect of the disclosure;

FIG. 4 is a perspective view of the downspout with an inlet segment, according to an aspect of the disclosure;

FIG. 5 is a schematic view of an inlet stream, a downspout stream, an exit stream and a fill stream of water flowing through a downspout with inlet segment and flowing into ice tray cavities, according to an aspect of the disclosure;

FIG. 6 is a schematic cross-sectional view of a fill line, downspout, ice tray cavities, and water entering into the ice tray from the downspout, according to an aspect of the disclosure;

FIG. 7 is a bottom plan view of the downspout with an inlet segment of FIG. 4, according to an aspect of the disclosure;

FIG. 7A is a bottom plan view of the downspout with an inlet segment of FIG. 4 showing a distance between opposing flutes, according to an aspect of the disclosure;

FIG. 7B is a bottom plan view of the downspout with an inlet segment of FIG. 4 showing a distance between opposing lobes, according to an aspect of the disclosure;

FIG. 8 is a cross-sectional view of the downspout with an inlet segment of FIG. 4 taken along line VIII-VIII, according to an aspect of the disclosure;

FIG. 9 is a side elevational view of the downspout with an inlet segment of FIG. 4, according to an aspect of the disclosure;

FIG. 9A is a cross-sectional view of the downspout taken along line IXA-IXA of FIG. 9, according to an aspect of the disclosure;

FIG. 9B is a cross-sectional view of the downspout taken along line IXB-IXB of FIG. 9, according to an aspect of the disclosure;

FIG. 10 is a top plan view of the downspout with an inlet segment of FIG. 4, according to an aspect of the disclosure; and

FIG. 11 is a perspective view of the downspout and a water delivery member, according to an aspect of the disclosure.

### DETAILED DESCRIPTION OF EMBODIMENTS

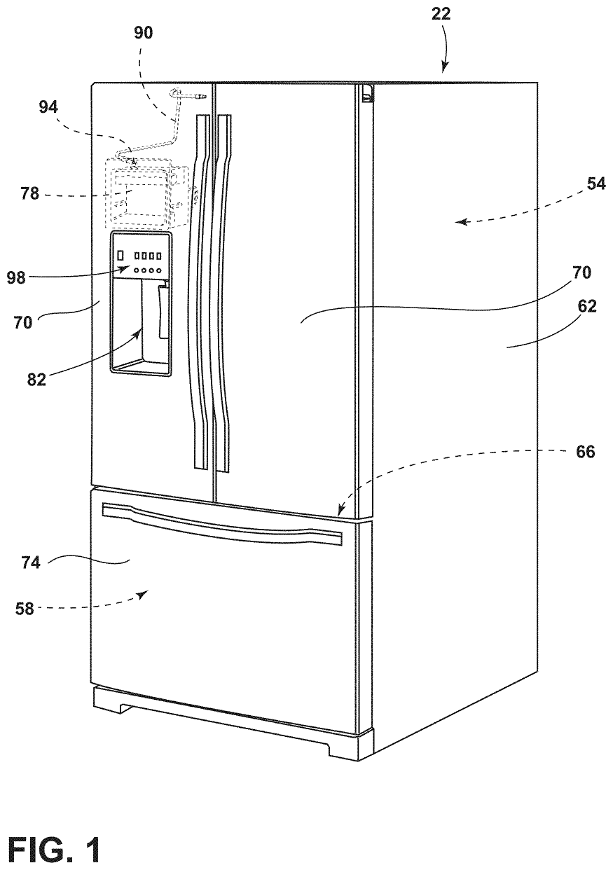

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIGS. 1-11, a downspout 10 for delivering water 14 to an ice tray 18 in a refrigerated appliance 22 is shown. The downspout 10 includes a downspout cavity 26. The downspout cavity 26 is defined by at least one flute 30 and at least one lobe 34. The downspout 10 for delivering water 14 to an ice tray 18 in a refrigerated appliance 22 also includes an inlet port 38. The inlet port 38 receives water 14. The at least one flute 30 and the at least one lobe 34 are configured to create a substantially laminar flow 42 of the water 14 received from the inlet port 38 along the at least one flute 30 and the at least one lobe 34.

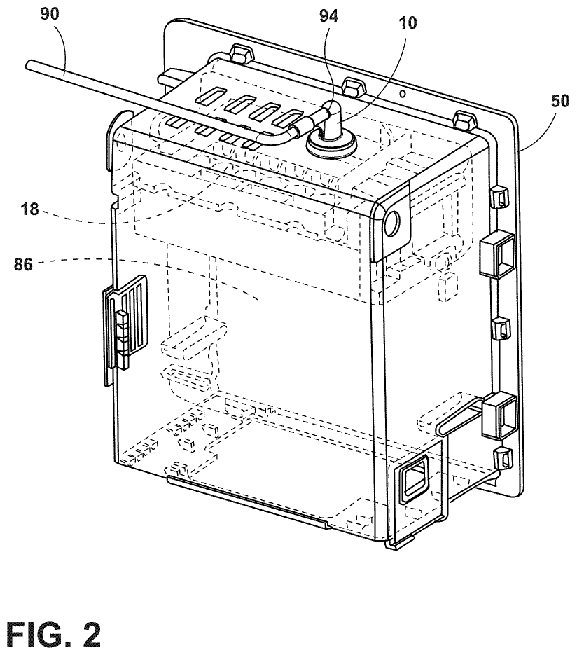

Referring to FIGS. 1 and 2, reference numeral 22 generally designates the refrigerated appliance 22 with an ice maker 50. The ice maker 50 may be used as a stand-alone appliance or within another appliance, such as a refrigerator. The ice-making process may be induced, carried out, stopped, and the ice harvested with little, or no user input. FIG. 1 generally shows a refrigerator of the French-door bottom mount type, but it is understood that this disclosure could apply to any type of refrigerator, such as a side-by-side, two-door bottom mount, or a top-mount type refrigeration unit.

As shown in FIGS. 1 and 2, the refrigerated appliance 22 may have a refrigerated compartment 54 configured to refrigerate consumables and a freezer compartment 58 configured to freeze consumables during normal use. Accordingly, the refrigerated compartment 54 may be kept at a temperature above the freezing point of water and generally below a temperature of from about 35° F. to about 50° F., more typically below about 38° F. and the freezer compartment 58 may be kept at a temperature below the freezing point of water.

In some instances, the refrigerated appliance 22 has a cabinet 62 and a liner within the cabinet 62 to define the refrigerated compartment 54 and the freezer compartment 58. A mullion 66 may separate the refrigerated compartment 54 and the freezer compartment 58.

The refrigerated appliance 22 may have one or more doors 70, 74 that provide selective access to the interior volume of the refrigerated appliance 22 where consumables may be stored. As shown, the refrigerated compartment 54 doors are designated 70, and the freezer door is designated 74. It is appreciated that the refrigerated compartment 54 may only have one door 70.

The icemaker 50 may be positioned within or near the door 70 and in an icemaker receiving space 78 of the appliance to allow for delivery of ice through the door 70 in a dispensing area 82 on the exterior of the appliance. The dispensing area 82 may be at a location on the exterior of the door 70 below the level of an ice storage bin 86 to allow gravity to force the ice down an ice dispensing chute in the refrigerated appliance door 70. The chute may extend from the storage bin 86 to the dispensing area 82 and ice may be pushed into the chute using an electrically power-driven auger.

With reference to FIGS. 1-3, the refrigerated appliance 22 may also have a water inlet that is fastened to and in fluid communication with a household supply of potable water. The water inlet may be fluidly engaged with one or more of a water filter, a water reservoir, and a water delivery member 90. The water delivery member 90 may include outlet 94 for dispensing water 14 into a downspout 10 that may be positionable above an ice tray 18. The refrigerated appliance 22 may also have a control board or controller that sends electrical signals to the one or more valves when prompted by a user through a user interface 98, which may be on the front face of a door, that water is desired or if an ice-making cycle is to begin.

With further reference to FIGS. 1-3, the icemaker 50 may be located at an upper portion of the icemaker receiving space 78. The ice storage bin 86 may be located below the icemaker 50 such that as ice is harvested, the icemaker uses gravity to transfer the ice from the icemaker to the ice storage bin 86. The ice tray 18 may include one or more ice cavities 102.

Within conventional appliances, during the ice cavity filling process, turbulent flow of water from a water delivery member or other water source that may include a downspout or a spigot may create a chaotic water surface in the cavities and/or splashing of water outside of the ice tray and into other areas of the ice maker. Water may land on other areas of the ice maker and water may freeze and prohibit other ice maker areas (for example, a motor for twisting or inverting an ice tray to release ice and/or an ice maker bail arm) from working properly. In some situations, turbulent flow of water from a water delivery member or other water source may cause a water spray in the ice maker. The water spray may cause poor ice quality and build up of ice on the ice maker motor and bail arm. Additionally, in some situations, incoming water from a water delivery member may be directed into a downspout in a manner that causes a chaotic flow of water out of the downspout. Thus, it is desirable to have a substantially laminar flow 42 of water 14 from a downspout outlet 94 or other water exit area into an ice tray 18.

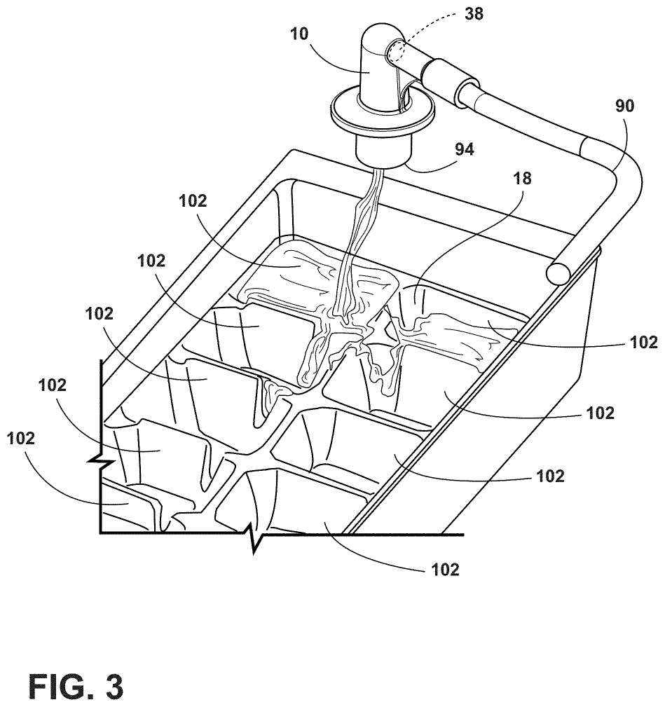

With reference to FIG. 3, a perspective view of a downspout 10 and water delivery member 90 that may be configured to achieve a substantially laminar flow 42 of water 14 from the inlet port 38, through the outlet 94, and to the ice tray cavities 102 is shown.

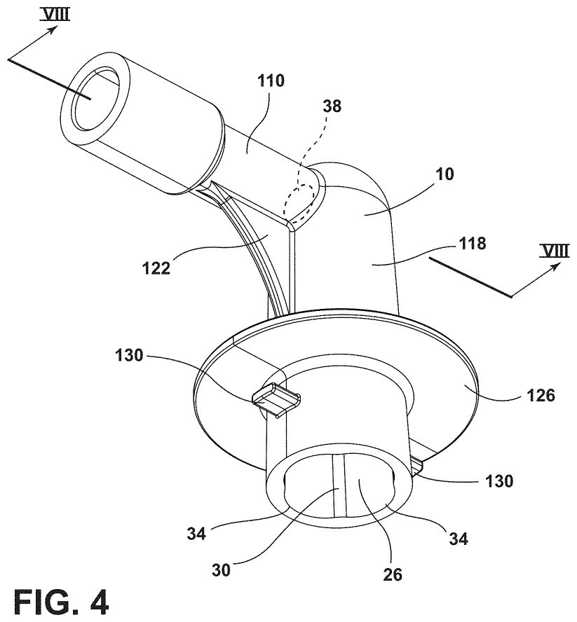

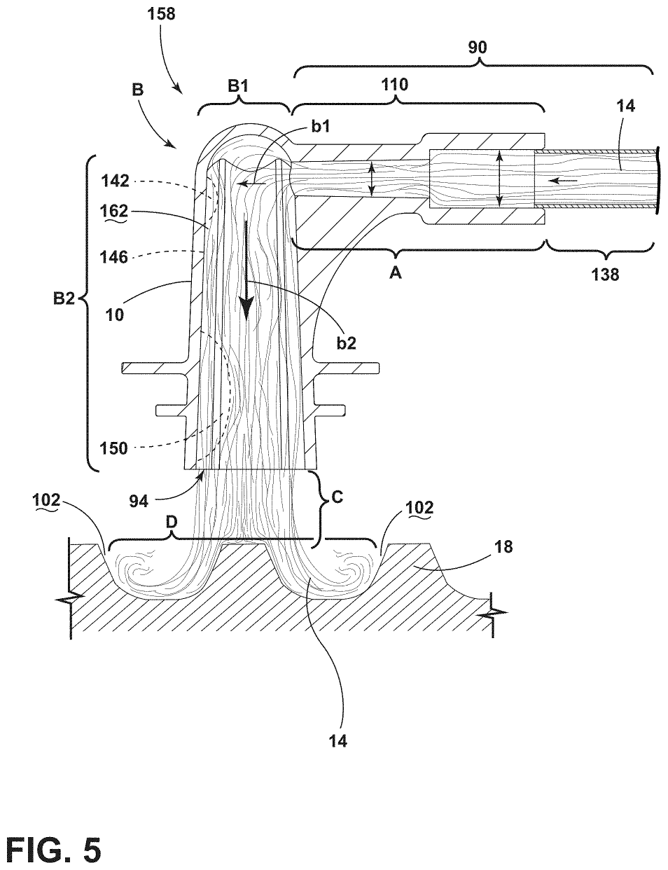

With reference to FIG. 4, a perspective view of the downspout 10 and inlet segment 110 is shown. The downspout 10 and inlet segment 110 may be configured facilitate a substantially laminar flow 42 of water 14 through the inlet segment 110 and the downspout 10 and into the ice cavities 102. The geometry of the downspout 10 and the inlet segment 110 may be configured to facilitate substantially laminar flow 42 of the water 14 within the downspout 10 and as an exit stream C (FIG. 5) that leaves the downspout 10 and travels into the ice cavities 102 of the ice tray 18. The downspout 10 may include a downspout cavity 26 having at least one flute 30 and at least one lobe 34. An inlet port 38 for receiving water 14 may be disposed in the downspout 10. The at least one flute 30 and the at least one lobe 34 may be configured to create a substantially laminar flow 42 of water 14 within the cavity. The downspout 10 may have a frustoconical shape 118. A flange 122 may extend from the inlet segment 110 to the downspout, and the flange 122 may support the downspout 10 and the inlet segment 110. A circular collar 126 may be disposed around the downspout 10 to assist in positioning the downspout 10 above the icemaker 50 and/or ice tray 18. A pair of opposing tabs 130 may extend from the downspout 10. The pair of opposing tabs 130 may assist in positioning the downspout 10 above the icemaker 50 and/or the ice tray 18. As such, the downspout 10 includes features that may improve use of the downspout 10 within an icemaker 50.

With reference to FIG. 5, water 14 traveling through the downspout 10 and the inlet segment 110 is shown. In the depicted aspect, the downspout 10 and the inlet segment 110 are a single part. A water fill line 138 may be coupled to the inlet segment 110. In the depicted aspect, the water delivery member 90 includes the fill line 138 and the inlet segment 110. The water 14 flowing through the inlet segment 110 and the downspout 10 and into the ice cavities 102 may be described as including several portions. The portions may include an inlet stream A, a downspout stream B, an exit stream C, and a fill stream D. The inlet stream A refers to the water stream in the inlet segment 110 prior to entry into the inlet port 38 of the downspout 10. The downspout stream B includes the stream within the downspout 10. The downspout stream B may be divided into a first downspout stream portion and a second downspout stream portion. The first downspout stream portion may include a lateral downspout stream B₁ that refers to water flow between the inlet port 38 and a first contact area 142 on the opposing surface 146 of the downspout cavity 26. The second downspout stream may include a longitudinal downspout stream B₂ that may flow from the first contact area 142 to at least a second contact area 150 disposed proximate the outlet 94 of the downspout 10. The exit stream C may refer to water 14 flowing from the outlet 94 of the downspout 10 to an ice tray 18 or water 14 in an ice tray 18. The fill stream D refers to water 14 that may have contacted the ice tray 18 or water 14 within the ice tray 18. To achieve non-turbulent and substantially laminar flow 42 of water 14 in one or more of an inlet stream A, a downspout stream B, an exit stream C, and a fill stream D, the downspout 10 and the inlet segment 110 may include specific geometries. A substantially laminar flow 42 may include a smooth flow that causes minimal splash or spray by the exit stream C as the exit stream C leaves the outlet 94 of the downspout 10 and enters the ice tray 18.

With continuing reference to FIG. 5, the flow of water 14 through the inlet segment 110 and the downspout 10 may be more particularly described. A water delivery system 158 for a refrigerated appliance 22 may include the inlet segment 110 that is positionable to deliver an inlet stream A through the inlet port 38 and a lateral downspout stream B₁ into the downspout cavity 26 in a lateral direction as shown by arrow b₁. The lateral downspout stream B₁ may travel from the inlet port 38 towards a first contact area 142 disposed on a surface of the downspout cavity 26. A longitudinal downspout stream B₂ may travel in the direction shown by arrow b₂. A second contact area 150 may be disposed on a surface of the downspout cavity 26 and between the first contact area 142 and the outlet 94. The second contact area 150 may be disposed over at least part of one or more lobes 34 (also referred to as elongated grooves) and the one or more flutes 30 (also referred to as elongated protuberances). The second contact area 150 is configured to facilitate substantially laminar flow 42 of water 14 between the first contact area 142 and the outlet 94. The inlet segment 110 may be transverse to the downspout 10 to direct the inlet stream A into the downspout cavity 26 (also referred to as hollowed-out portion) as the lateral downspout stream B₁ in a direction transverse to a cavity surface 162 that opposes the inlet port 38. As such, the design of the downspout is such that a downspout stream B of water 14 may flow in a smooth, substantially laminar and non-turbulent manner within the downspout cavity 26 and as part of the exit stream C that leaves the downspout. The exit stream C may contact the ice tray 18, and the fill stream D may flow smoothly and may have minimal splash as it enters the ice cavities 102. Further, the fill stream D may create a non-chaotic water surface in the ice cavities 102.

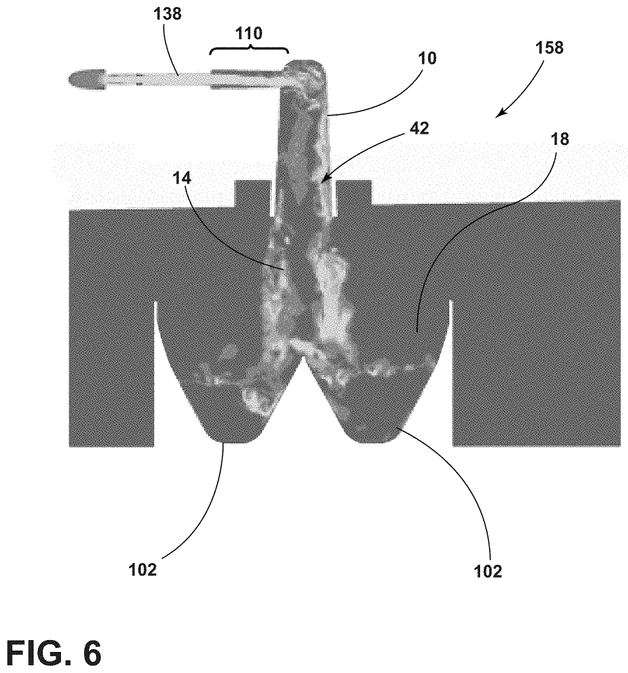

FIG. 6 shows a simulation of water 14 traveling through the water delivery system 158. The water 14 may travel through a fill line 138, an inlet segment 110, and a downspout 10. The water 14 may enter the ice cavities 102 of an ice tray 18 with a substantially laminar flow 42.

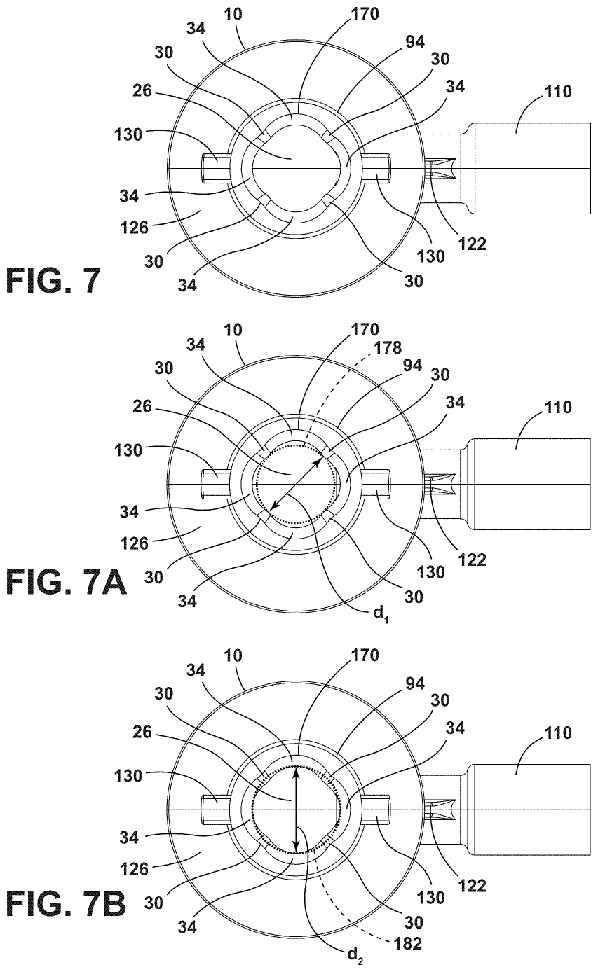

With reference to FIG. 7, the configuration of the downspout cavity 26 may facilitate substantially laminar flow 42 of water 14 within the downspout cavity 26 and into the ice tray 18. The downspout cavity 26 may be defined by four flutes 30 and four lobes 34 that define a generally quatrefoil shape 170 of the downspout cavity 26. The outer surface 174 of the downspout 10 defines a generally frustoconical shape 118. As previously described, the collar 126 and the tabs 130 extend from the downspout 10. Additionally, the inlet segment 110 extends outward from the downspout 10. The flange 122 may connect the downspout 10 and the inlet segment 110.

With reference to FIG. 7A, a first circle 178 has been superimposed on the downspout outlet 94 to show a distance between opposing flutes 30. The distance between opposing flutes 30 is the diameter d₁ of the first circle 178.

With reference to FIG. 7B, a second circle 182 has been superimposed on the downspout outlet 94 to show a distance between opposing lobes 34. The distance between opposing lobes 34 is the diameter d₂ of the second circle 182. In the aspect shown, the diameter d₂ of the second circle 182 is greater than the diameter d₁ of the first circle 178.

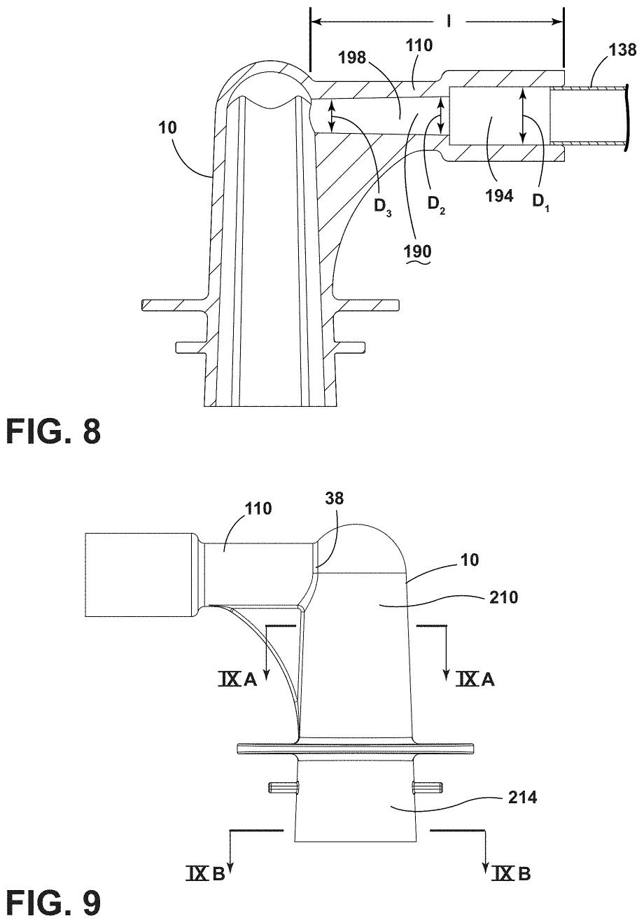

With reference to FIG. 8, a cross-sectional view of the downspout 10 and the inlet segment 110, as shown in FIG. 8, is shown to illustrate additional features. The channel 190 is shown with a first channel portion 194 and a second channel portion 198. In the aspect shown, the first channel portion 194 and the second channel portion 198 may have generally circular cross-sections. The first channel portion 194 may include a first diameter D₁. The second channel portion 198 is shown tapering between the first channel portion 194 and the inlet port 38. The second channel portion 198 includes diameter D₂ proximate the first channel portion 194. The second channel portion 198 includes diameter D₃ proximate the inlet port 38. The diameter D₂ may be larger than a diameter D₃ of the second channel portion 198 proximate the inlet port 38. As such, the diameters D₁, D₂, and D₃ may be selected to regulate the velocity of the inlet stream A and the lateral downspout stream B₁. As shown, the inlet segment 110 may have multiple cross-sectional variances along a length l of the channel. In the depicted aspect, the inlet segment 110 includes at least two cross-sectional variances (for example, two or more of D₁, D₂ or D₃) along the length of the inlet segment 110. The inlet segment 110 may include a first interior dimension (for example, D₁) and a second interior dimension (for example, D₂ or D₃). The second interior dimension may be less than the first interior dimension.

With continued reference to FIG. 8, in various aspects, the first channel portion 194 may receive a fill line 138. The fill line 138 may be inserted into the first channel portion 194. The fill line 138 may have a diameter less than the first channel portion 194 diameter D₁. A seal may be disposed between or around the fill line 138 and the first channel portion 194.

In various aspects, the downspout 10, the inlet segment 110, and the fill line 138 may be separate parts. In various aspects, the inlet segment 110 may be part of the fill line 138. In various aspects, the inlet segment 110 may be part of the downspout 10.

In various aspects, water 14 may be pumped into the water fill line 138 or water delivery member 90 at various pressures. In some aspects, the pressures may be in the range of from approximately 10 Pounds per Square Inch (PSI) to approximately 240 PSI. Exemplary water pressures at which water 14 may be released into the fill line 138 are approximately 20 PSI, approximately 60 PSI, and approximately 120 PSI. The water fill line 138 may be designed with a selection of flow velocity in the water fill line 138 (including the inlet segment 110) that provides for a continuous stream of water 14 that forms at least an inlet stream A and a lateral downspout stream B₁. Water flow velocity, water pressure, and inlet segment 110 channel diameters D₁, D₂, D₃, and a fill line 138 diameter may be variables that contribute to the flow characteristics of at least the inlet stream A and the lateral downspout stream B₁. If the lateral downspout stream B₁ contacts the first contact area 142 (FIG. 5) in a non-chaotic manner, then it follows that the flow of a longitudinal downspout stream B₂, the exit stream C, and the fill stream D may also have a substantially laminar flow 42. The velocities of the inlet stream A and the lateral downspout stream B₁ may be variables relevant to whether the lateral downspout stream B₁ contacts the first contact area 142 in a chaotic or non-chaotic manner. The downspout 10 described herein provides geometries that produce a substantially laminar flow 42 of water 14 in response to a wide range of water 14 pressures.

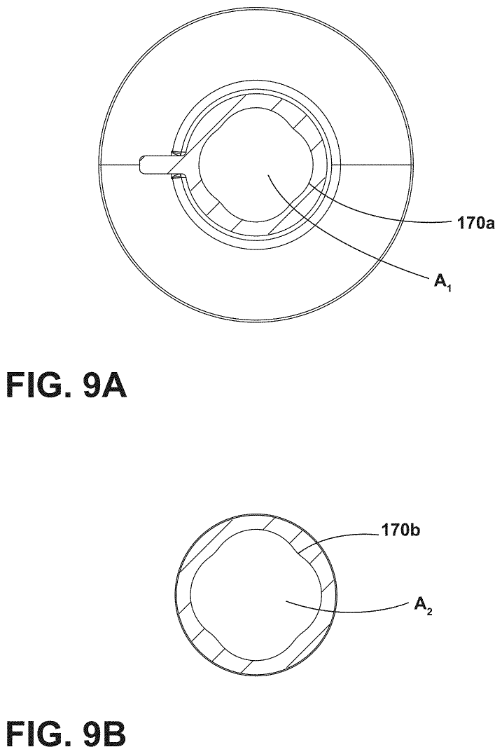

The downspout 10 may include additional features relevant to water flow within the downspout cavity 26. FIG. 9 shows a side view of the downspout 10 and inlet segment 110. The downspout 10 includes a water ingress portion 210 that flares outward to a water egress portion 214. The water ingress portion 210 is proximate the inlet port 38. The water egress portion 214 is proximate the outlet 94. A cross-section IXA of the downspout cavity 26 taken along the water ingress portion 210 is shown in FIG. 9A. A cross-section IXB of the downspout cavity 26 taken along the water egress portion 214 is shown in FIG. 9B. The cross-sectional area A₁ taken at the water ingress portion 210 is smaller than the cross-sectional area A₂ taken at the water egress portion 214. The first cross-sectional area A₁ may have a generally quatrefoil shape 170a. The second cross-sectional area A₂ may have a generally quatrefoil shape 170b.

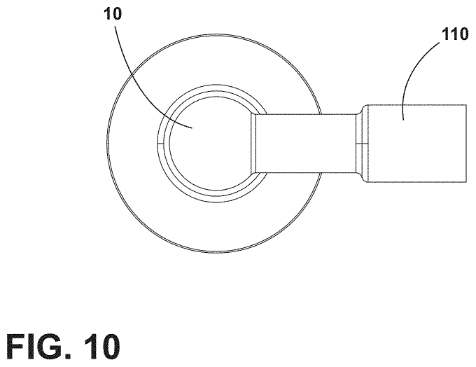

With reference to FIG. 10, a top plan view of the downspout 10 and an inlet segment 110 as shown.

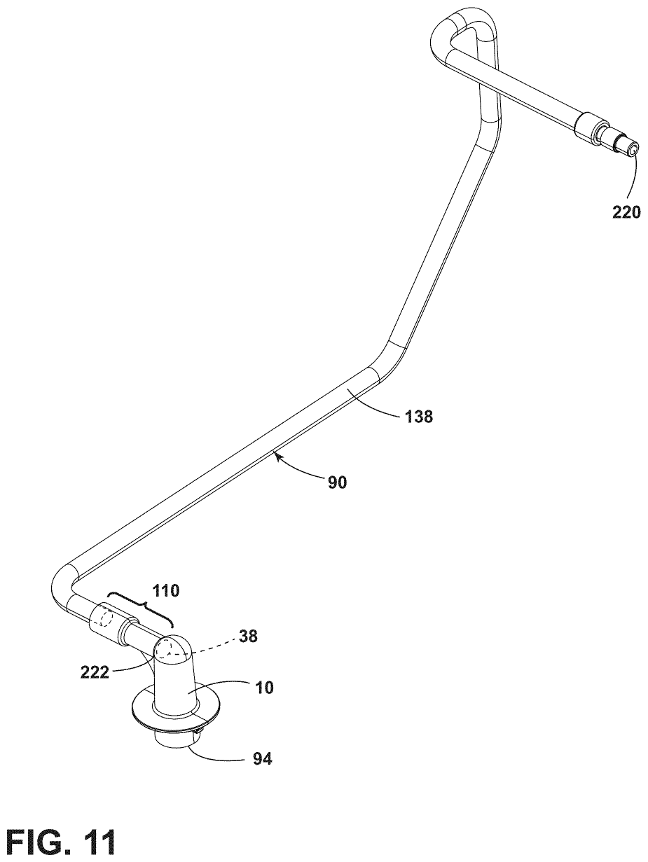

Referring to FIG. 11, the additional details of the water delivery member 90 and the downspout 10 are shown. The water delivery member 90 generally comprises a first end 220 coupled to a water source and a second end 222 coupled to the inlet port 38. As previously stated, the water delivery member 90 may include the inlet segment 110 and the fill tube 138.

A variety of advantages may be derived from use of the present disclosure. The substantially laminar flow 42 achieved by the configuration of the downspout 10 minimizes water 14 splashing within the ice maker 50 in areas other than the ice tray 18. Similarly, the configuration of the downspout 10 minimizes a chaotic water flow. Chaotic water flow may contribute to a chaotic ice surface of frozen ice cubes.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A downspout for delivering water to an ice tray in a refrigerated appliance comprising:
a cavity defined by at least one flute and at least one lobe; and
an inlet port for receiving water, wherein the at least one flute and at least one lobe are configured to create a substantially laminar flow of the water received from the inlet port along the at least one flute and the at least one lobe.

2. The downspout of claim 1, wherein the at least one flute and the at least one lobe include four flutes and four lobes, respectively, that define a generally quatrefoil shape of the cavity.

3. The downspout of claim 2, wherein a first distance between opposing flutes defines a first diameter, wherein a second distance between opposing lobes defines a second diameter, and wherein the second diameter is greater than the first diameter.

4. The downspout of claim 1, wherein the downspout includes a water ingress portion proximate the inlet port and a water egress portion that is configured to be positionable proximate the ice tray.

5. The downspout of claim 4, wherein the cavity includes a first cross-sectional area at the water ingress portion and a second cross-sectional area at the water egress portion, wherein the first cross-sectional area is smaller than the second cross-sectional area.

6. The downspout of claim 5, wherein the first cross-sectional area comprises a first generally quatrefoil shape.

7. The downspout of claim 6, wherein the second cross-sectional area comprises a second generally quatrefoil shape.

8. The downspout of claim 5, wherein the first cross-sectional area comprises a first generally quatrefoil shape and wherein the second cross-sectional area comprises a second generally quatrefoil shape.

9. The downspout of claim 2, further comprising:
a water delivery member coupled to the inlet port, wherein the water delivery member is configured to direct a stream of water from the inlet port to a surface of the cavity.

10. The downspout of claim 9, wherein the surface of the cavity is opposed to the inlet port.

11. A water delivery system for an ice tray of a refrigerated appliance comprising:
a downspout including:
a cavity defined by:
one or more elongated protuberances; and
one or more elongated grooves;
an inlet port;
an outlet positionable above the ice tray; and
a water delivery member coupled to the inlet port of the downspout.

12. The water delivery system of claim 11, wherein the one or more elongated protuberances and the one or more elongated grooves include opposing elongated protuberances interspersed by opposing elongated grooves.

13. The water delivery system of claim 12, wherein the water delivery member comprises:
a first end coupled to a water source;
a second end coupled to the inlet port; and
an inlet segment coupled to the inlet port and extending away from the downspout.

14. The water delivery system of claim 13, wherein the inlet segment is positionable to deliver an inlet stream and a first portion of a downspout stream through the inlet port and into the cavity in a lateral direction towards a first contact area disposed on a wall of the cavity.

15. The water delivery system of claim 14, wherein a second contact area is disposed on the wall of the cavity and between the first contact area and an outlet, wherein the second contact area is disposed over at least part of the one or more elongated protuberances and the one or more elongated grooves, and wherein the second contact area is configured to facilitate a substantially laminar flow of water between the first contact area and the outlet.

16. The water delivery system of claim 15, wherein the inlet segment is substantially transverse to the downspout.

17. A water delivery system for a refrigerated appliance, comprising:
an elongated downspout including:
a hollowed-out portion defined by one or more lobes and one or more flutes arranged in an alternating lobe and flute configuration along a surface of the hollowed-out portion, wherein the one or more lobes and the one or more flutes are longitudinally disposed in a direction of the elongated downspout;
a fill line including:
a first end coupled to a water source and a second end coupled to the elongated downspout; and
an inlet segment coupled to the downspout and the fill line and extending toward the first end of the fill line, wherein the inlet segment includes multiple cross-sectional variances along a length of a channel.

18. The water delivery system of claim 17, wherein the inlet segment includes a first interior dimension and a second interior dimension and wherein the second interior dimension is less than the first interior dimension.

19. The water delivery system of claim 18, wherein the inlet segment and the downspout are a single part and wherein the inlet segment is positioned to direct water to a first contact area disposed on a surface of the hollowed-out portion of the downspout such that the water forms a substantially laminar flow along the one or more lobes and the one or more flutes.

20. The water delivery system of claim 17, wherein the inlet segment engages the hollowed-out portion at a lobe of the one or more lobes.
